(19) United States
(12) Patent Application Publication
(10) Pub. No.: US 2019/0093991 A1
(43) Pub. Date: Mar. 28, 2019

(54) Metallic Ballistic Shield

(71) Applicant: Brett Cryer, Melbourne, FL (US)

(72) Inventor: Brett Cryer, Melbourne, FL (US)

(21) Appl. No.: 16/136,851

(22) Filed: Sep. 20, 2018

Related U.S. Application Data
(60) Provisional application No. 62/563,016, filed on Sep. 25, 2017.

(51) Int. Cl. F41H 5/08; F41H 5/04; B32B 9/00; B32B 15/01; B32B 15/04; B32B 3/26

(52) U.S. Cl. CPC F41H 5/08; F41H 5/0442; B32B 9/005; B32B 15/011; B32B 2571/02; B32B 3/266; F41H 5/0421; F41H 5/0492; B32B 2307/536; B32B 15/04

(57) ABSTRACT

A hand-carried ballistic shield for use by civilians and law enforcement is disclosed, comprising a ballistic metal sheet, one or more handles or attached accessories, and a bolt buffer element between the ballistic sheet and the handles or accessories. The sheet may be further faced with ceramic or hardened steel in order to improve ballistic performance against hardened core or higher velocity bullets. As a preferred method of manufacture, any holes in the ballistic metal sheet are made solely through mechanical means such as drilling or punching.

### CROSS REFERENCE TO RELATED APPLICATIONS

“Metallic Ballistic Shield” Provisional Application, Application # 62/563,016

### STATEMENT REGARDING FEDERALLY SPONSORED RESEARCH/DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Since the days of antiquity when the first men raided each other with spears and stones, man has used armor and shields to protect himself from his enemies. In later millennia wicker and wood gave way to bronze and then steel, yet still armor and shields were commonly used by men facing combat. Armor and shields fell into disuse as the weight and bulk of steel required to protect against increasingly more powerful weapons precluded their widespread use. When struck by contemporary firearms, thin steel was easily penetrated, while even thicker steels which stopped the threat round could split or spall resulting in potentially injurious debris being thrown from the back of the armor or shield.

More recently, personal body armor has made a comeback as the invention of high performance fibers (aramid, UHMWPE, etc.) allowed the creation of soft armor vests providing reasonable ballistic protection with tolerable weight and bulk. These vests have now become standard issue for law enforcement and military personnel.

Ballistic shields made from the same materials are also used by law enforcement personnel in high risk operations, as are lightweight polycarbonate non-ballistic shields for use in riot control activities.

In the modern world threats are not limited to law enforcement and military personnel. Crime of all sorts challenges the common civilian, such that many take it upon themselves to protect themselves and their families. While various lethal and non-lethal offensive armaments are widely available, few good defensive options exist. Soft body armor as worn by law enforcement and military personnel is expensive, slow to don in time of duress, and protects only a modest portion of the body. Even when a threat round is successfully stopped by the armor, the impact can impart a severe and potentially incapacitating blunt trauma. Ballistic shields can be readied rapidly and easily and have minimal risk of blunt trauma, but current ballistic shields are expensive, and bulky to store and use. Furthermore, modern armor and shields have limited ability to sustain hits near the edge of the panel, near previous hits, or near any holes in the panel (such as for a ballistic shield handle anchor), and the high performance fibers used in their construction deteriorate with age, heat, and moisture, resulting in products with functional product lives of 10 years or less.

What has been unavailable until now is a ballistic defense solution which combines rapidity of access, ease of use, high ballistic coverage, durability, and long product life, all at a widely affordable cost and reasonable weight.

The objective of the present invention is to provide a bullet-proof shield for use by civilians and law enforcement agents, which is sized to substantially protect the torso, arms, and neck of the user.

A further objective of the present invention is to provide a bullet-proof shield with ballistic robustness and chronological durability superior to that of currently available ballistic shields, at a cost compatible with widespread use by civilians and law enforcement personnel.

Other advantages of the invention will become apparent to those skilled in the art during the course of the following detailed description.

### SUMMARY OF THE INVENTION

The invention comprises a ballistic shield utilizing modern high quality metal with superior ballistic resistance performance. A hand-carried shield is ready as soon as it is lifted and facing the threat; in comparison to worn body armor which needs to be pulled over the head or arms, shifting into position, and then strapped, buckled, or otherwise secured in place. A shield also provides greater ballistic coverage, typically 300 square inches or more, compared to the 110-140 square inches of protection of a typical soft body armor main insert panel. What sets the present invention apart from products current available or envisioned in the prior art is the use of modern metals to provide the ballistic resistance of the shield, which provides unrivaled durability and shelf life at a potentially much lower cost than comparable products made from fiber-based technologies.

In one embodiment of the design the shield is made substantially from steel. Modern steel manufacturing techniques are far superior to those used when steel was last in widespread use for armor and shields, resulting in material with superior mechanical properties including hardness, impact resistance, and ductility all of which are important to ballistic resistance performance. Optimal carbon, alloy, or stainless steels for this application have a carbon content between 0.05% and 0.55% and are processed to a Brinell hardness rating between 350 and 600. Examples of steels with these properties include MIL12560, MIL46100, AR400, and AR500, which are used for vehicle armor plating, shooting range targets, and high-wear industrial applications. These materials are sufficiently hard to cause a lead or mild steel core bullet to mushroom upon impact, thereby distributing the impact energy across a broader area of the shield, while remaining ductile enough to yield slightly with the impact, thereby improving energy absorption. Overall these properties allow for a steel shield that provides ballistic resistance at thicknesses and weights lower than previously possible.

Other metals may provide similar ballistic performance to the steels described above at similar or lower weights and these are also considered an embodiment of the invention. Examples include aluminum alloys such as 5059, 5053, 5456, and 7039, and titanium alloys such as 6AI-4V (Grade 5). While these materials may not be as hard as the steel described above, their lower density, greater ductility, and/or impact resistance serve to provide ballistic performance equal to or better than the steel described above for a given areal density (weight per square foot). These materials are also more corrosion resist than steel.

When faced with a hardened core or high velocity threat round, a layer of extra hard metal or ceramic may be added to the front of the shield. Because materials of this hardness are brittle, they are used in conjunction with the metal shield described above and are not suitable as stand-alone shield materials. The impact of the bullet against the extra hard facing layer shatters both, and the metal shield described above then deflects or absorbs the remaining material and kinetic energy. The facing layer may be a continuous sheet or manufactured from multiple smaller segments or tiles. Examples of facing layer materials include aluminum oxide, alumina zirconia, aluminum nitride, silicon carbide, silicon nitride, titanium diboride, and boron carbide ceramics; metal matrix carbides, and various steels hardened to Rockwell C 58 or greater. The facing layer may be secured to the shield using adhesive, heat bonded, or mechanically held in position such as by using a U-shaped rim, cover layer, or other means.

In the ideal embodiment the shield consists of a single sheet of metal with one or more attached handles with which it may be carried by the user. To this core a facing layer may be attached as warranted for the intended application. The shield may be flat for ease of storage, or curved for increased stiffness and to help deflect any incoming threat rounds. There may be additional holes in the shield besides those required for mounting the handles including peepholes, vision slits, gun ports, or those for mounting slings, lights, phones, cameras, or other accessories. The handle or securement strap may be manufactured from any sufficiently robust material including plastic, metal, wood, leather, or rope. The front face of the shield may be covered with cloth, polymer, or other material to capture any impacting rounds and prevent bullet or facing layer fragments from splashing off the shield. The back face of the shield may be partially or entirely padded for user comfort and to prevent blunt trauma to the user's hand or arm in the event of a hit.

A further feature of the present invention is that the means of any creating holes in the metal is accomplished through mechanical means such as drilling, reaming, punching, water-jet cutting, or the like. Typically materials of this hardness would be processed using plasma cutting, laser cutting, friction drilling, or other techniques using heat to aid in the processing, but these techniques can leave rough edges, and the heat involved can compromise the ballistic performance of the steel in areas adjacent to the cut site. In one embodiment of the invention any holes are made solely though mechanical means, while in another the holes are pre-drilled using plasma, laser, or other heat-involving technique, then further processed with any of the mechanical means described to remove any rough edges and heat affected zones in the metal adjacent to the hole.

A particular feature of the present invention is its ability to sustain one or more hits by threat rounds directly on or immediately adjacent to the handle bolts without failure. Current ballistic shields manufactured from high performance fibers typically fail when hit near the handle bolt because the fibers are severed in order to create the hole for the bolt, and the adjacent areas of the ballistic panel are therefore weakened. When a fiber-based shield is hit at the handle bolt, even if the bullet does not fully penetrate, the shield is typically distorted to the point where the handle is broken or comes loose from the panel, compromising the functionality of the shield. In the present invention, the use of a modern metal for the ballistic sheet, the manufacturing techniques described above, and extra high strength bolts all contribute to allow the shield to sustain hits at the handle bolts without failure. Best performance of the design is achieved when the handle bolts have a tensile strength greater than 150 ksi, more preferably 180 ksi or greater.

The ability of the shield to resist strikes at the handle bolts is further enhanced by the presence of a bolt buffer element between the ballistic sheet and any components or accessories attached to the shield, such as the handle assembly. The bolt buffer allows the ballistic sheet to flex or distort when hit by a threat projectile without transmitting sufficient force to the attached component to cause a breakage which compromises the functionality of the shield. Ideally the bolt buffer is stiff enough to allow the handle or other component to be attached firmly to the shield yet compliant enough to compress or break and tear away in the event of a hit on the underlying ballistic sheet. In the preferred embodiment the bolt buffer consists of one or more elastomer washers. In alternate embodiments envisioned under the present invention the bolt buffers are made from polymer rings, wood shims, rubber pads, coil springs, bevel springs, wound cord, soft metal washers, or other materials and geometries which fulfill the shock absorbance function described.

### BRIEF DESCRIPTION OF THE DRAWINGS

FIG. 1 shows a frontal view of the shield of the present invention

FIG. 2 shows a rear view of the shield of the present invention

FIG. 3 shows a top view of the shield of the present invention, including one embodiment of the handle assembly.

FIGS. 4-7 show alternate embodiments of the handle assembly.

### DETAILED DESCRIPTION OF THE INVENTION

Referring to the drawings, in which similar numerals designate like parts throughout the drawings,

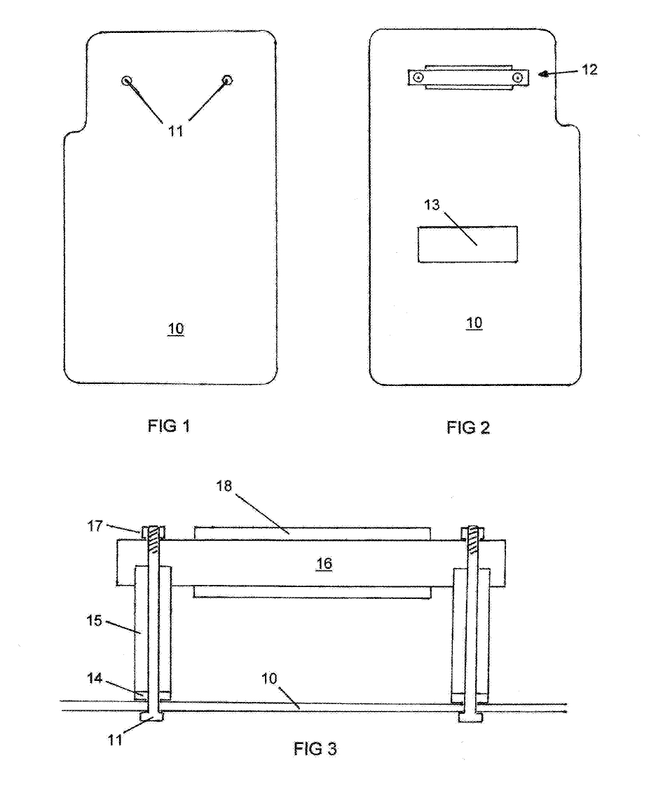

FIGS. 1 and 2 show the shield according to the present invention, comprising a ballistic sheet 10 with a handle bolts 11 securing the handle assembly 12. A foam or cloth pad 13 between the user's arm and the ballistic sheet improves user comfort and reduces blunt trauma in the event of a hit on the shield.

The ballistic sheet 10 is manufactured from a single layer of metal such as steel, aluminum, or titanium. The corners of the ballistic sheet 10 may be square or rounded (as shown in FIGS. 1 and 2) in order to trim weight and eliminate sharp corners. The ballistic sheet 10 may have one or more notches or cutouts to aid in aiming a flashlight, firearm or other item around the shield. The ballistic sheet 10 may be flat for ease of storage, or curved for improved ballistic efficiency and to help deflect any incoming threat rounds to the side. In a generic embodiment the ballistic sheet 10 may be 15″ wide and 25″ tall, which would be approximately optimal for indoor use by a civilian. This size shield would typically include one handle and weigh approximately 13 pounds. A heavier shield offering increased ballistic protection in terms of protected area and/or threat level may utilize a second handle. Shields as small as 12″×18″ and as large as 30″×60″ may satisfy the intent of the invention.

The ballistic sheet 10 may be coated with one or more thin layers of zinc, chrome, or polymer in order to improve its visual appearance and protect it from scratches and corrosion.

FIG. 3 shows further detail relating to one embodiment of the handle construction, in which the handle bolts 11 are threaded through the bolt buffer 14, handle support members 15, the handle grip 16, and anchored by nuts 17. In this embodiment the handle buffer is a rubber or polymer washer. The handle grip 16 and handle supports 15 are envisioned as being manufactured from rods or tubes of an impact resistant polymer or a metal, for example polycarbonate, ABS, magnesium, aluminum, titanium, or steel. The handle bolts 11 and nuts 17 are manufactured from a high strength metal such as steel or titanium. In the preferred embodiment the handle bolts and nuts are made from Grade 9 high strength steel. The handle grip may be covered with a cushion 18 made from foam, cloth, leather, or wound cord to improve user grip quality and comfort.

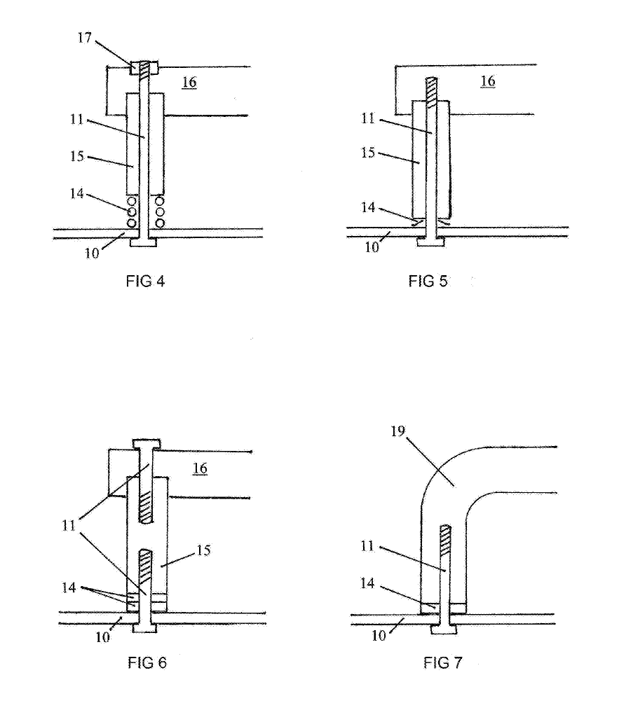

FIG. 4 shows a partial view of an alternate embodiment of the handle assembly, in which the bolt buffer 14 is a coil spring and the nut 17 is recessed into the handle grip 16.

FIG. 5 shows a partial view of another alternate embodiment of the handle assembly, in which the bolt buffer 14 is a bevel spring and the handle bolt 11 is threaded directly into the handle grip 16.

FIG. 6 shows a partial view of another alternate embodiment of the handle assembly, in which a second bolt buffer 14 has been placed and in which two handle bolts 11 are threaded directly into the handle support 15.

FIG. 7 shows a partial view of another alternate embodiment of the handle assembly, in which the handle grip and supports are made from a single bent or injection molded rod or bar 19.

Further variations of the above embodiments envisioned include use of washers between the bolts, nuts, and other components to ease assembly, optimize spacing, or reinforce the design against ballistic hits; the use of multiple nuts or locking nuts on each bolt, or the use of screws or rods and crosspins instead of bolts.

While detailed embodiments of the present invention are disclosed herein, it will be understood that the embodiments described are merely examples of particular means in which the invention may be constructed and are not intended to be restrictive. Various modifications to the forms and details of the design can be made by those skilled in the art and without departing from the spirit of the invention. Thus the scope of the invention should be determined by the appended claims and their legal equivalents, rather than limited by the examples given.

What is claimed is:

1. A hand-carried ballistic shield wherein the ballistic resistance is provided by a sheet of metal capable of withstanding, without any penetration of bullet material, a strike from a metallic bullet with a mass of at least 4 grams and an impact velocity of at least 330 meters per second.

2. The shield according to claim 1 in which the metal is MIL46100 steel, AR500 steel, Aluminum 5059, Aluminum 5053, Aluminum 5456, Aluminum 7039, or Titanium 6AI-4V (Grade 5).

3. The shield according to claim 1 in which the metal has an areal density of 11.5 pounds per square foot or less.

4. The shield according to claim 1 in which the metal has an areal density of 7.5 pounds per square foot or less.

5. The shield according to claim 1 in which the metal has an areal density of 5.5 pounds per square foot or less.

6. The shield according to claim 1 with a frontal surface area of 300 square inches or more.

7. The shield according to claim 1 wherein the sheet of metal provides a rearward layer of the shield and is augmented by a harder frontward layer consisting of a ceramic, metal matrix carbide, or steel with Rockwell C hardness of 58 or greater.

8. The shield according to claim 7 in which the facing layer is aluminum oxide, alumina zirconia, aluminum nitride, silicon carbide, silicon nitride, titanium diboride, boron carbide, or tungsten carbide.

9. A hand-carried ballistic shield wherein the ballistic resistance is provided by a sheet of steel containing between 0.05% and 0.55% carbon and processed such that it has a Brinell hardness between 350 and 650.

10. The shield according to claim 9 in which the steel is MIL12560, MIL46100, AR400, AR500, or a proprietary ballistic steel product with carbon content and hardness in the ranges specified, such as Ramor 500, Ramor 550, or Ramor 600.

11. The shield according to claim 9 in which the thickness of the steel is 0.28″ or less.

12. The shield according to claim 9 in which the thickness of the steel is 0.18″ or less.

13. The shield according to claim 9 in which the thickness of the steel is 0.135″ or less.

14. The shield according to claim 9 with a frontal surface area of 300 square inches or more.

15. A hand-carried ballistic shield wherein the ballistic resistance is provided by a sheet of metal, in which any holes in said metal are made by non-thermal mechanical means such as drilling, reaming, punching, water jet cutting, or the like.

16. The shield according to claim 15, in which any holes are made solely by said mechanical means.

17. The shield according to claim 15, in which any holes may be made by plasma, laser, or other heat-inducing technique followed by processing by any of said mechanical means to substantially remove any heat affected zones from the original drilling.

18. A hand-carried ballistic shield with one or more attached handles, in which at least one of the structural components of the handle is set apart from direct contact with the ballistic panel by at least one element with substantially greater compressibility than the primary handle material.

19. The shield according to claim 18, in which the compressive element is a ring, disk, shim, or pad made from elastomer, polymer, foam, cloth, wood, or soft metal.

20. The shield according to claim 18, in which the compressive element is a metallic spring.
